(19) United States
(12) Patent Application Publication
(10) Pub. No.: US 2020/0039254 A1
(43) Pub. Date: Feb. 6, 2020

(54) PRINTING APPARATUS, CONTROL METHOD OF PRINTING APPARATUS AND STORAGE MEDIUM

(71) Applicant: CANON KABUSHIKI KAISHA, Tokyo (JP)

(72) Inventor: Yuji Takayama, Tokyo (JP)

(21) Appl. No.: 16/518,062

(22) Filed: Jul. 22, 2019

(30) Foreign Application Priority Data
Aug. 1, 2018 (JP) 2018-144922

(51) Int. Cl. B41J 13/00

(52) U.S. Cl. CPC B41J 13/0009

(57) ABSTRACT

By controlling drive of a first drive motor that drives a feed roller feeding a printing medium and a second drive motor that drives a conveyance roller conveying the printing medium fed by the feed roller, a preceding printing medium and a following printing medium are conveyed continuously. Raised-temperature detection processing to detect a raised-temperature state of the first drive motor and the second drive motor is performed based on a predetermined condition. In a case where one drive motor of the first drive motor and the second drive motor does not satisfy the predetermined condition and the other driver motor satisfies the predetermined condition, the raised-temperature detection processing of the one drive motor that does not satisfy the predetermined condition is caused to be performed after suspending the continuous conveyance.

### BACKGROUND OF THE INVENTION

### Field of the Invention

The present invention relates to a printing apparatus that prints an image on a plurality of printing media conveyed continuously, a control method of a printing apparatus, and a storage medium.

### Description of the Related Art

Japanese Patent Laid-Open No. 2008-12850 has described a configuration that detects a raised-temperature state of a drive motor based on a pulse width of a drive pulse of the drive motor in a printing apparatus that PWM—controls the drive motor of a conveyance roller that conveys a printing medium.

In a case where the raised-temperature state of the drive motor is detected as in Japanese Patent Laid-Open No. 2008-12850, on a condition that a printing medium is nipped by a nip portion of the conveyance roller, the load of the drive motor varies, and therefore, the detection accuracy of the raised-temperature state of the drive motor is reduced. Because of this, at the detection timing of the raised-temperature state of the drive motor, it is necessary to suspend the conveyance of the printing medium so that the printing medium is not nipped by the nip portion of the conveyance roller. Further, in a printing apparatus including a plurality of drive motors for driving a plurality of conveyance rollers, in order to similarly detect the raised-temperature state of each of those drive rollers, it is necessary to suspend the conveyance of the printing medium for each detection timing of the raised-temperature state, which is different in each drive motor. However, in a case where the conveyance of a printing medium is stopped frequently as described above, a reduction in throughput of the printing apparatus will result. This is not limited to the processing to detect the raised-temperature state of a plurality of drive motors and is the same also in a case where the conveyance of a printing medium is suspended for each execution timing of a plurality of various pieces of processing accompanied by suspension of the conveyance of a printing medium.

### SUMMARY OF THE INVENTION

The present invention provides a printing apparatus capable of performing a plurality of pieces of processing accompanied by suspension of conveyance of a printing medium while suppressing a reduction in throughput of the printing apparatus, a control method of the printing apparatus, and a storage medium.

In the first aspect of the present invention, there is provided a printing apparatus comprising:

a first drive motor that drives a feed roller feeding a printing medium;

a second drive motor that drives a conveyance roller conveying the printing medium fed by the feed roller;

a printing unit configured to print an image on the printing medium conveyed by the conveyance roller;

a conveyance unit configured to control drive of the first drive motor and the second drive motor and perform continuous conveyance that conveys a preceding printing medium and a following printing medium continuously;

a raised-temperature detection processing unit configured to perform raised-temperature detection processing to detect a raised-temperature state of the first drive motor and the second drive motor based on a predetermined condition; and

a control unit configured to perform, in a case where one drive motor of the first drive motor and the second drive motor does not satisfy the predetermined condition and the other drive motor satisfies the predetermined condition, control so as to perform, after suspending the continuous conveyance, the raised-temperature detection processing of the one drive motor that does not satisfy the predetermined condition.

In the second aspect of the present invention, there is provided a control method of a printing apparatus that prints an image on a printing medium to be conveyed, the control method comprising:

a continuous conveyance step of continuously conveying a preceding printing medium and a following printing medium by controlling drive of a first drive motor that drives a feed roller feeding the printing medium and a second drive motor that drives a conveyance roller conveying the printing medium fed by the feed roller;

a raised-temperature detection step of performing raised-temperature detection processing to detect a raised-temperature state of the first drive motor and the second drive motor based on a predetermined condition; and

a control step of causing, in a case where one drive motor of the first drive motor and the second drive motor does not satisfy the predetermined condition and the other drive motor satisfies the predetermined condition, the raised-temperature detection processing of the one drive motor that does not satisfy the predetermined condition to be performed after suspending the continuous conveyance.

In the third aspect of the present invention, there is provided a non-transitory computer readable storage medium storing a program for causing a computer to perform a control method of a printing apparatus that prints an image on a printing medium to be conveyed, the control method comprising:

a continuous conveyance step of continuously conveying a preceding printing medium and a subsequent printing medium by controlling drive of a first drive motor that drives a feed roller feeding the printing medium and a second drive motor that drives a conveyance roller conveying the printing medium fed by the feed roller;

a raised-temperature detection step of performing raised-temperature detection processing to detect a raised-temperature state of the first drive motor and the second drive motor based on a predetermined condition; and

a control step of causing, in a case where one drive motor of the first drive motor and the second drive motor does not satisfy the predetermined condition and the other drive motor satisfies the predetermined condition, the raised-temperature detection processing of the one drive motor that does not satisfy the predetermined condition to be performed after suspending the continuous conveyance.

According to the present invention, it is possible to suppress a reduction in throughput of a printing apparatus by reducing frequency of suspension of conveyance of a printing medium.

Further features of the present invention will become apparent from the following description of exemplary embodiments with reference to the attached drawings.

### BRIEF DESCRIPTION OF THE DRAWINGS

FIG. 1 is an outline perspective diagram of a printing apparatus in a first embodiment of the present invention;

FIG. 2 is a section diagram of the printing apparatus in FIG. 1;

FIG. 3 is a configuration diagram of hardware in the printing apparatus in FIG. 1;

FIG. 4 is a configuration diagram of software in the printing apparatus in FIG. 1;

FIG. 5 is a flowchart for explaining a printing operation in the printing apparatus in FIG. 1;

FIG. 6 is a flowchart for explaining raised-temperature detection processing of a motor in the printing apparatus in FIG. 1;

FIG. 7 is a flowchart for explaining a printing operation corresponding to raised-temperature detection results of a motor in the printing apparatus in FIG. 1;

FIG. 8 is a flowchart for explaining a printing operation of a printing apparatus in a second embodiment of the present invention; and

FIG. 9 is a flowchart for explaining head maintenance processing in FIG. 8.

### DESCRIPTION OF THE EMBODIMENTS

In the following, with reference to the attached drawings, embodiments of the present invention are explained.

### First Embodiment

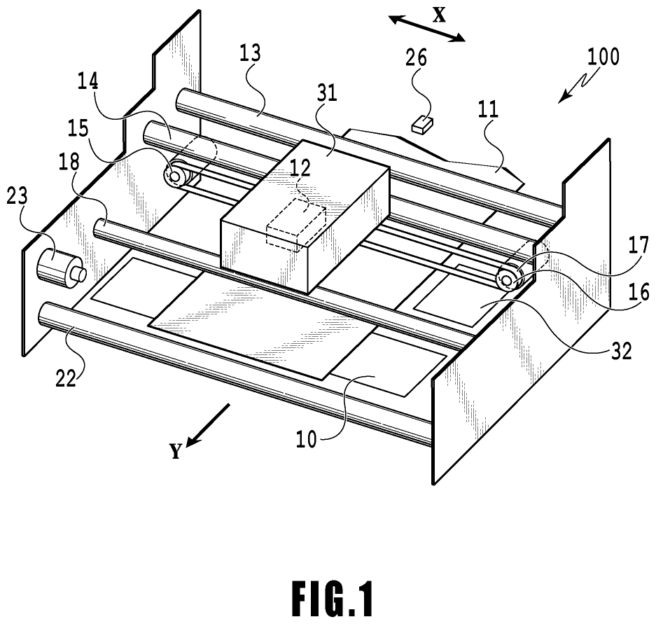

FIG. 1 is a perspective diagram of an important portion of a printing apparatus in a first embodiment of the present invention. A printing apparatus (printer) 100 of this example includes a carriage 31 capable of mounting one or a plurality of print heads 12 (hereinafter, explanation is given by supposing that one print head is mounted). The carriage 31 is guided by a guide axis 14 movably in a main scanning direction of an arrow X. At one end of a movement range of the carriage 31, a pulley-attached carriage motor 15 is arranged and at the other end, an idle pulley 16 is arranged. A timing belt 17 put on between the pulley of the carriage motor 15 and the idle pulley 16 is linked to the carriage 31. In order to prevent rotation of the carriage 31 with the guide axis 14 as a center, a support member 18 extending in parallel to the guide axis 14 is installed and the carriage 31 is supported slidably by the support member 18. Further, in a non-printing area in the printing apparatus 100, a maintenance mechanism 32 for performing maintenance of the print head 12 is provided. The print head 12 in this example is an ink jet print head capable of ejecting ink from an ejection port (opening of a nozzle) and a plurality of ejection ports is arrayed in a direction intersecting with (in a case of this example, perpendicular to) the main scanning direction. It is possible to eject ink from those ejection ports by using an ejection energy generation element, such as an electro-thermal conversion element (heater) or a piezo element. Because of this, the maintenance mechanism 32 includes a recovery mechanism that performs recovery processing for keeping favorable a state of ejecting ink from the ejection port of the print head 12. The recovery mechanism includes, for example, a cap (not shown schematically) for capping the nozzle of the print head 12 at the time of non-printing, a wiper (not shown schematically) for wiping processing to wipe off foreign matter, such as ink, attached to a surface (ejection port surface) on which the ejection port is formed, and the like.

Further, by driving a conveyance motor (first drive motor) 23, a first conveyance roller 13 and a second conveyance roller 22 (first conveyance unit) rotate. Due to this, a printing medium 11 is conveyed in an arrow Y direction (sub scanning direction) intersecting with (in a case of this example, perpendicular to) the movement direction (main scanning direction) of the carriage 31. The conveyance motor 23 is a DC motor. The printing apparatus 100 is provided with an edge sensor 26 for detecting the printing medium 11 within the conveyance path of the printing medium 11. The printing medium 11 is conveyed in the arrow Y direction on a platen 10. The carriage 31 is rotatable upward in FIG. 1 with the guide axis 14 as a center.

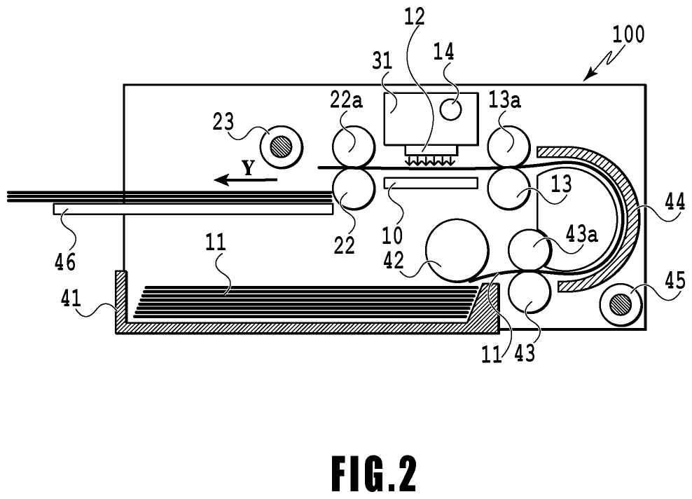

FIG. 2 is a section diagram of the printing apparatus 100. The printing apparatus 100 is provided with a cassette 41 containing a plurality of the printing media 11. At the time of the operation to feed printing media, the printing media 11 set in the cassette 41 are picked up by a pickup roller 42 in order from the uppermost printing medium. The picked up printing medium 11 is fed in the direction toward the print head 12 along a conveyance path 44 by a third conveyance roller 43 and an opposing roller 43a in opposition thereto. The pickup roller 42 and the third conveyance roller 43 (second conveyance unit) are linked to a feed motor 45 (second drive motor) via a power transmission system, not shown schematically, so as to be rotated by the feed motor 45. Further, the first conveyance roller 13 and the second conveyance roller 22 are linked to the conveyance motor 23 via a power transmission system, not shown schematically, so as to be rotated by the conveyance motor 23. The feed motor 45 is a DC motor like the conveyance motor 23.

The printing medium 11 fed by the third conveyance roller 43 is conveyed by the first conveyance roller 13 and the second conveyance roller 22 that rotate in synchronization with the third conveyance roller 43, and opposing rollers 13a and 22a in opposition thereto, and the printing medium 11 is discharged onto a discharge tray 46. The feed operation of the printing medium 11 is not limited only to the feed operation from the cassette 41 arranged at the bottom of the printing apparatus 100 and for example, it may also be possible to arrange the pickup roller 42 at the rear (right side in FIG. 2) of the printing apparatus 100.

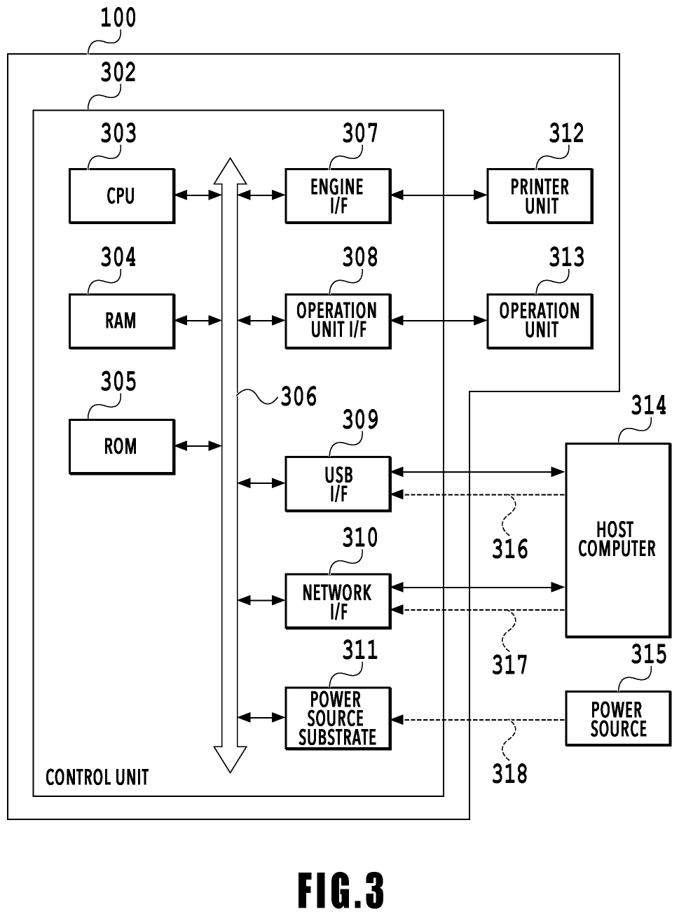

FIG. 3 is a block diagram for explaining the hardware configuration of the printing apparatus 100. A CPU 303 included in a control unit 302 of the printing apparatus 100 performs various kinds of control, such as control of power source turning on and printing control, by loading control programs stored in a ROM 305 onto a RAM 304 and reading and executing the control programs as needed. The RAM 304 is a main storage memory of the CPU 303 and used as a work area and a temporary storage area for loading various programs stored in the ROM 305. The ROM 305 stores image data, various programs, and various kinds of setting information. As the ROM 305, it is possible to use an auxiliary storage device, such as a hard disk, in addition to a flash storage. In the printing apparatus 100 in this example, the one CPU 303 performs each piece of processing shown in flowcharts, to be described later, by using one memory (RAM 304). However, the configuration is not limited to this and for example, it is also possible to perform each piece of processing shown in flowcharts, to be described later, by the cooperation of a plurality of CPUs and a plurality of RAMs, ROMs, and storages. Further, it may also be possible to perform part of the processing such as this by using a hardware circuit.

An engine interface (hereinafter, I/F) 307 connects a printer unit 312 and the control unit 302. Image data to be printed in the printer unit 312 is transferred from the control unit 302 via the engine I/F 307 and printed on the printing medium 11, such as paper, by the printer unit 312. An operation unit I/F 308 connects an operation unit 313 and the control unit 302. The operation unit 313 is provided with a liquid crystal display unit having a touch panel function, operation keys, and the like and functions as a reception unit configured to receive user instructions. A USB I/F 309 and a network I/F 310 control communication with a host computer (host device) 314 connected to the printing apparatus 100. A power source substrate 311 changes the voltage of power supplied from a power source 315 via a power source cable 318 and supplies the power to the printing apparatus 100. The power source substrate 311 may include a storage battery capable of storing power.

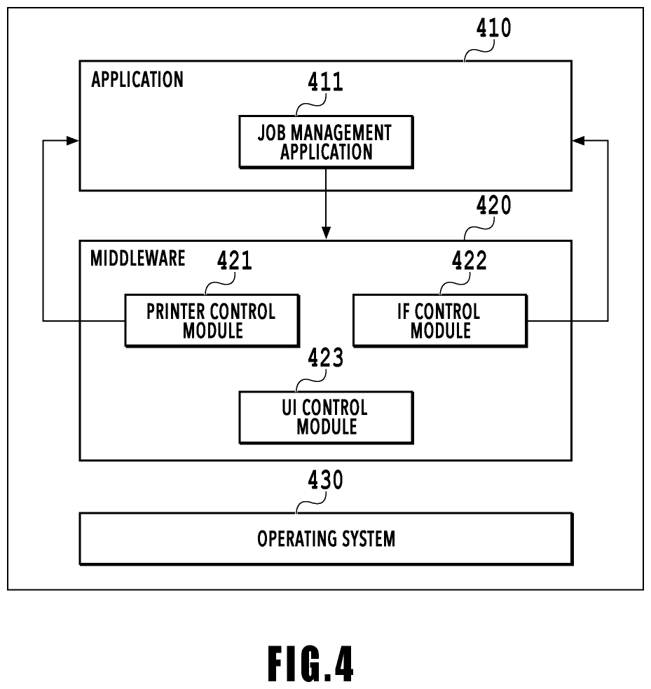

FIG. 4 is the software configuration diagram of control programs loaded onto the RAM 304 for controlling each hardware module. The control programs are roughly divided into three blocks: an application 410 for managing applications, middleware 420 for controlling devices via various I/Fs, and an operating system 430 for managing control of the entire printing apparatus.

The operating system 430 provides fundamental functions for the control unit 302 to execute the control programs. The middleware 420 includes a software group for controlling the I/F between the printer and each physical device. In this example, the middleware 420 includes a printer control module 421 as a module that controls the engine I/F 307. Further, the middleware 420 includes an I/F control module 422 for controlling the USB I/F 309 and the network I/F 310 as devices used for communication with the host computer 314. Furthermore, the middleware 420 includes a UI control module 423 for controlling the operation unit I/F 308, and the like. The application 410 implements functions, such as printing, provided to a user by the printing apparatus 100 by causing each device to operate via the middleware. For example, in a case where the UI control module 423 detects that a user has given instructions to perform printing via the operation unit 313 and the operation unit I/F 308, the application 410 is notified of this. By receiving the notification, the application 410 performs a job management application 411 for performing printing. The job management application 411 performs the printing operation by controlling the printer unit 312 via the engine I/F 307 by using the printer control module 421 of the middleware 420.

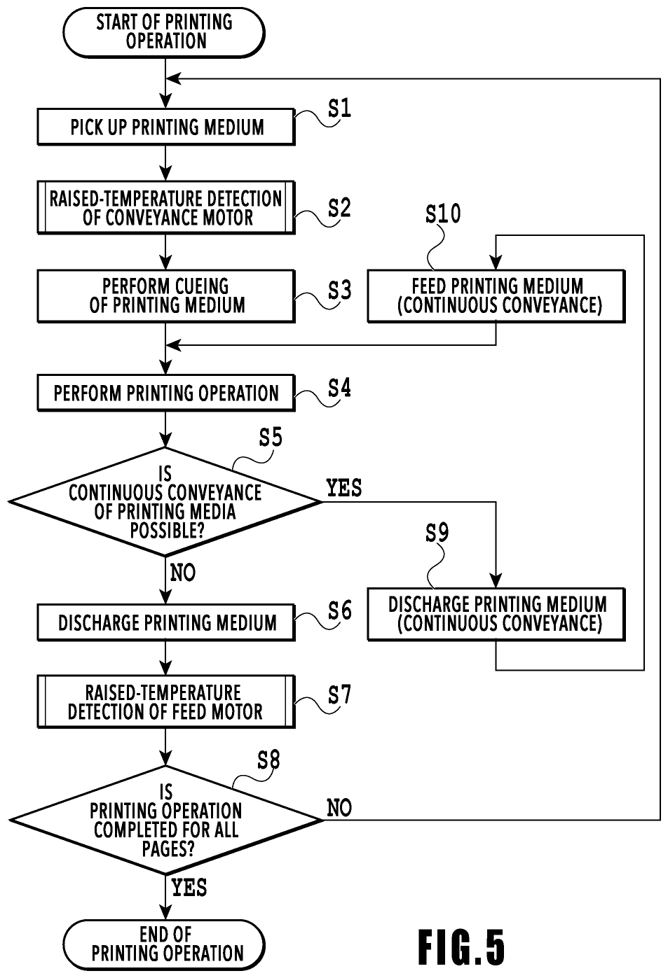

FIG. 5 is a flowchart for explaining the printing operation of the printing apparatus 100 in the present embodiment and symbol “S” in explanation of each piece of processing means a step.

The printing apparatus 100 receives instructions (hereinafter, job) to perform the printing operation from the host computer 314 via the USB I/F 309 and the network I/F 310. Due to this, the printer control module 421 starts the processing in FIG. 5 by controlling the printer unit 312 via the engine I/F 307. In this example, the printing apparatus 100 receives a job from the host computer 314, but it may also be possible for the printing apparatus 100 to generate a job for itself.

First, the CPU 303 of the printing apparatus 100 picks up the uppermost printing medium 11 of a plurality of the printing media 11 set in the cassette 41 by the pickup roller 42 and conveys the printing medium 11 up to the position before the first conveyance roller 13 by the third conveyance roller 43 (S1). As described above, the conveyance position of the printing medium 11 is taken to be the position before the first conveyance roller 13, that is, the position at which the printing medium 11 is not nipped by the nip portion between the first conveyance roller 13 driven by the conveyance motor 23 and the opposing roller 13a. The reason is that in a case where the printing medium 11 is nipped between the first conveyance roller 13 and the opposing roller 13a, the load of the conveyance motor 23 varies and the detection accuracy of the raised-temperature detection (S2) of the conveyance motor 23, which is performed next, is reduced. The control for detecting raised temperature of the conveyance motor 23 will be described later.

After this, the CPU 303 conveys the printing medium 11 (S3) by synchronously rotating the third conveyance roller 43, the first conveyance roller 13, and the second conveyance roller 22. By the conveyance (S3), the printing medium 11 is located at the start position of the printing operation (S4) of the printing medium 11. That is, cueing of the printing medium 11 is performed. At this time, in a case where it is obvious that the printing medium 11 is not nipped between the third conveyance roller 43 and the opposing roller 43a, it is not necessary to rotate the third conveyance roller 43. The series of operation from the pickup of the printing medium 11 (S1) until the cueing of the printing medium 11 (S3) is the feed operation of the printing medium 11. In the printing operation (S4), the operation (printing scan) to eject ink from the nozzle of the print head 12 while moving the carriage 31 in the main scanning direction and the conveyance operation of the printing medium 11 by the first conveyance roller 13, the second conveyance roller 22, and the third conveyance roller 43 are repeated. Due to this, an image is printed on the printing medium 11 corresponding to one page. At this time, in a case where it is obvious that the printing medium 11 is not nipped between the third conveyance roller 43 and the opposing roller 43a, it is not necessary to rotate the third conveyance roller 43.

The CPU 303 discharges the printing medium 11 on which an image is printed by the printing operation onto the discharge tray 46 by the first conveyance roller 13, the second conveyance roller 22, and the third conveyance roller 43 (S6). At this time, in a case where it is obvious that the printing medium 11 is not nipped between the third conveyance roller 43 and the opposing roller 43a, it is not necessary to rotate the third conveyance roller 43. After this, the CPU 303 detects the raised-temperature state of the feed motor 45 (S7). As will be described later, this raised-temperature detection (S7) of the feed motor 45 is the same processing of the raised-temperature detection (S2) of the conveyance motor 23. As described above, after discharging the printing medium 11 on which an image is printed, that is, after bringing about the state where the printing medium 11 is not nipped by the nip portion between the third conveyance roller 43 driven by the feed motor 45 and the opposing roller 43a, the raised-temperature state of the feed motor 45 is detected (S7). The reason is that as in the case with the raised-temperature detection of the conveyance motor 23, in a case where the printing medium 11 is nipped between the third conveyance roller 43 driven by the feed motor 45 and the opposing roller 43a, the detection accuracy of the raised-temperature detection of the feed motor 45 (S7) is reduced. In a case where the printing operation of the printing media 11 corresponding to all the pages as the target of the printing in the job is completed, the CPU 303 terminates the series of processing in FIG. 5 and in a case where the printing operation is not completed, the CPU 303 returns the processing to the pickup operation at S1.

The series of processing such as this (S1 to S4, S6 to S8) is the fundamental processing in the printing operation and the situation of the printing medium 11 within the printing apparatus 100 is different from a case of continuous conveyance (S9, S10), to be described later. Between the start of feed of the printing medium 11 (S1) and the completion of discharge (S8), the printing medium 11 nipped between the first conveyance roller 13, the second conveyance roller 22, and the third conveyance roller 43 and the opposing rollers 13a, 22a, and 43a in opposition thereto is only one. That is, after the preceding printing medium is discharged onto the discharge tray 46, the printing medium that follows is picked up by the pickup roller 42.

As will be described later, in a case of determining that it is possible to continuously convey the printing medium 11 (S5), the CPU 303 performs the discharge operation (S9) and the feed operation (S10) of the printing medium 11 continuously. These operations (S9, S10) are called together continuous conveyance. For convenience of explanation, these two operations (S9, S10) are separated. However, these two operations (S9, S10) are operations to continuously convey the printing medium 11 so that cueing is performed for the following printing medium 11, which is the target of printing of the next image, up to the printing position at the same time the preceding printing medium 11 for which printing of an image is completed is discharged onto the discharge tray 46. Because of this, at the point in time of the execution of these operations (S9, S10), there is a possibility that the printing medium 11 is nipped between the first conveyance roller 13, the second conveyance roller 22, and the third conveyance roller 43, and the opposing rollers 13a, 22a, and 43a thereof. The printing medium 11 having the possibility of being nipped is the printing medium 11 for which printing of an image is completed or the next printing-target printing medium 11. The continuous conveyance includes the operation to continuously convey the printing media 11 by reducing the interval between the preceding printing medium 11 and the following printing medium 11 in order to improve productivity by improving throughput of the printing apparatus 100 and it may also be possible to convey the printing media 11 continuously in such a manner that a part of the preceding printing medium 11 and a part of the following printing medium 11 overlap. For example, it may also be possible to convey the printing medium 11 by overlapping the rear end portion in the conveyance direction of the printing medium 11 on which an image is being printed with the front end portion in the conveyance direction of the next printing-target printing medium 11.

After the printing operation (S4), the CPU 303 determines whether or not continuous conveyance of the printing medium 11 is possible at the timing the printing medium 11 on which an image is printed is discharged. As described previously, it is necessary to perform the raised-temperature detection of the conveyance motor 23 (S2) in the state where the printing medium 11 is not nipped between the first conveyance roller 13 and the second conveyance roller 22, which are driven by the conveyance motor 23, and the opposing rollers 13a and 22a in opposition thereto. Similarly, it is necessary to perform the raised-temperature detection of the feed motor 45 (S7) in the state where the printing medium 11 is not nipped between the third conveyance roller 43 driven by the feed motor 45 and the opposing roller 43a. Consequently, in a case where the raised-temperature detection of the conveyance motor 23 (S2) or the raised-temperature detection of the feed motor 45 (S7) is performed, the continuous conveyance is not possible and it is necessary to suspend the continuous conveyance while the detection is being performed. Thus, in a case where it is necessary to perform the raised-temperature detection of the conveyance motor 23 (S2) or the raised-temperature detection of the feed motor 45 (S7) at the time of determination of whether or not the continuous conveyance of the printing medium 11 is possible (S5), the CPU 303 determines that the continuous conveyance is not possible and advances the processing to the next discharge processing (S6). On the other hand, in a case where it is not necessary to perform the raised-temperature detection of the conveyance motor 23 (S2) or the raised-temperature detection of the feed motor 45 (S7) at the time of the determination (S5), the CPU 303 determines that the continuous conveyance is possible and advances the processing to S9.

As described above, the raised-temperature detection of the conveyance motor 23 (S2) and the raised-temperature detection of the feed motor 45 (S7) are processing that can be performed at the time the conveyance of the printing medium 11 is suspended. The CPU 303 resumes the conveyance of the printing medium after termination of the execution of these processing. A method of determining whether the execution of these processing is necessary will be described later.

For the last printing medium 11 corresponding to the final printing-target page in the job, the continuous conveyance is not possible, and therefore, the CPU 303 advances the processing to the discharge processing (S6) after printing an image on the last printing medium 11 of the job such as this. Further, depending on the configuration of the printing apparatus 100, there is an apparatus that determines whether or not to perform continuous conveyance at the point in time of the feed operation of the printing medium, and in this case, it is sufficient to perform the determination processing (S5) at the point in time of the feed operation of the printing medium.

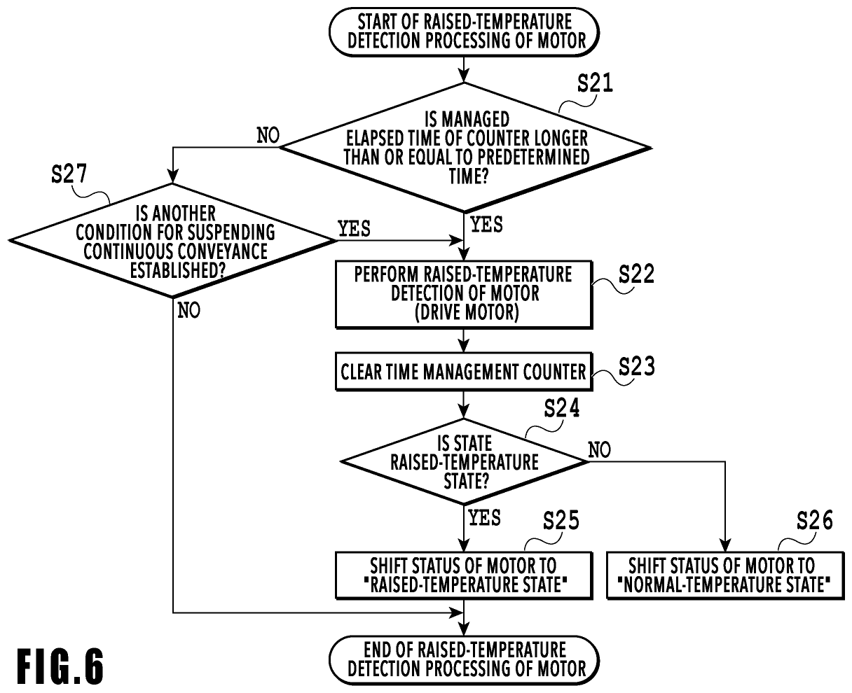

FIG. 6 is a flowchart for explaining raised-temperature detection processing of the DC motors (the conveyance motor 23 and the feed motor 45) in the printing apparatus 100 in the present embodiment and symbol “S” in explanation of each piece of processing indicates a step. In the raised-temperature detection of the conveyance motor 23 (S2) and the raised-temperature detection of the feed motor 45 (S7), the processing in FIG. 6 is performed individually.

First, the CPU 303 counts the elapsed time after performing the previous raised-temperature detection of the DC motors (the conveyance motor 23 and the feed motor 45) by using a time management counter. Then, the CPU 303 determines whether or not the count time, that is, the elapsed time (managed elapsed time) is longer than or equal to a predetermined time (S21). The elapsed time is also referred to in the determination processing at S5 in FIG. 5 described previously. In a case where the elapsed time is longer than or equal to the predetermined time, the CPU 303 determines that the continuous conveyance of the printing medium 11 is not possible (S5 in FIG. 5) and advances the processing to the discharge processing of the printing medium 11 (S6 in FIG. 5).

In a case where the elapsed time is longer than or equal to the predetermined time in the raised-temperature detection processing in FIG. 6, the CPU 303 drives the motors (the conveyance motor 23 and the feed motor 45) in order to detect the raised-temperature state of those motor (S22). The rotation speed of those motors is controlled by PWM control and the higher the temperature of the motor rises, the larger the drive power per unit time becomes and the pulse width of the drive pulse of the motor becomes large. Further, during the period of time of acceleration of the motor, the drive power is large, and therefore, the influence of the temperature of the motor is more significant than that during the period of time of drive other than acceleration of the motor. In this example, during the period of time of acceleration of the motor, the time in which the pulse width of the drive pulse of the motor exceeds a predetermined threshold value is accumulated and the accumulated time is used as information for detecting the raised-temperature state of the motor.

After performing the raised-temperature detection by driving the motor (S22), the CPU 303 clears the count time of the time management counter and causes the time management counter to start count again (S23). After this, the CPU 303 detects the raised-temperature state of the motor based on the results of the comparison between the accumulated time acquired at S22 and the predetermined time. That is, in a case where the accumulated time exceeds the predetermined time, the CPU 303 determines that the motor is in the raised-temperature state and sets the status of the motor to “raised-temperature state” (S25). On the other hand, in a case where the accumulated time does not exceed the predetermined time, the CPU 303 determines that that motor is in the normal-temperature state and sets the status of the motor to “normal-temperature state” (S26).

In a case where the determination at S21 indicates that the count time of the time management counter (managed elapsed time) is not longer than or equal to the predetermined time, the CPU 303 determines whether or not another condition for suspending the continuous conveyance of the printing medium 11 is established (S27). In a case where the condition is established, the continuous conveyance is not possible, and therefore, the CPU 303 performs the raised-temperature detection of the motor even though the managed elapsed time of the time management counter is not longer than or equal to the predetermined time (S22). On the other hand, in a case where the condition is not established, the continuous conveyance is possible, and therefore, the processing in FIG. 6 is terminated. In the raised-temperature detection processing of the conveyance motor 23, as another condition for suspending the continuous conveyance, the condition that the managed elapsed time of the time management counter for the feed motor 45 is not longer than or equal to the predetermined time is included. Further, in the raised-temperature detection processing of the feed motor 45, as another condition for suspending the continuous conveyance, the condition that the managed elapsed time of the time management counter for the conveyance motor 23 is not longer than or equal to the predetermined time is included.

Specifically, a case is explained where the managed elapsed time of the time management counter for the conveyance motor 23 is longer than or equal to the predetermined time and the managed elapsed time of the time management counter for the feed motor 45 is not longer than or equal to the predetermined time in the raised-temperature detection processing of the feed motor 45. In this case, the CPU 303 determines that the continuous conveyance of the printing medium 11 is not possible at S5 in FIG. 5 and suspends the continuous conveyance. After that, the CPU 303 advances the processing from S21 to S27 because the managed elapsed time of the time management counter for the feed motor 45 is not longer than or equal to the predetermined time in the raised-temperature detection processing in FIG. 6 that performs the raised-temperature detection (S7) of the feed motor 45. At this point in time, the managed elapsed time of the time management counter for the conveyance motor 23 is longer than or equal to the predetermined time, and therefore, the CPU 303 advances the processing from S27 to S22. A case where the raised-temperature detection of the conveyance motor 23 is performed is a case where the managed elapsed time of the time management counter for the conveyance motor 23 is longer than or equal to the predetermined time and the continuous conveyance of the printing medium 11 is not possible. At S22 in FIG. 6, by making use of that the continuous conveyance is not possible, it is possible to perform the raised-temperature detection of the feed motor 45. That is, by the processing at S27 in FIG. 6, it is possible to increase productivity in the printing apparatus by reducing the frequency of suspension of the continuous conveyance of the printing medium 11 at S5 in FIG. 5.

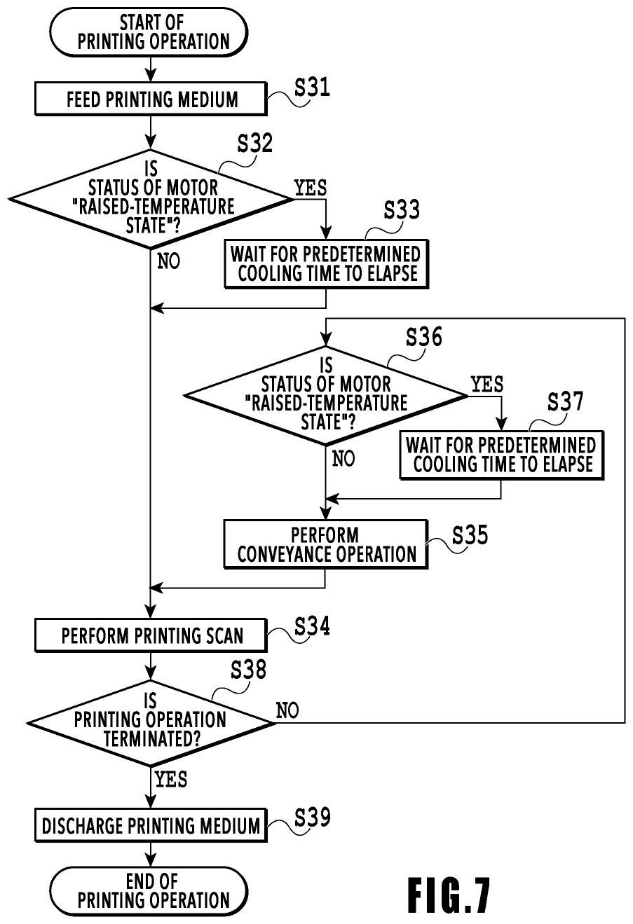

FIG. 7 is a flowchart for explaining the printing operation corresponding to the raised-temperature detection results of the motor and symbol “S” in explanation of each piece of processing means a step.

First, the CPU 303 feeds the printing medium 11 (S31) and after that, determines whether or not the status of the conveyance motor 23 or the feed motor 45 is the raised-temperature state (S32). In a case where the status of the motor is the raised-temperature state, the CPU 303 performs a printing scan (S34) after stopping the motor for a predetermined cooling time (S33) in order to cancel the raised-temperature state, that is, to bring the motor into the normal-temperature state. On the other hand, in a case where the status of the motor is not the raised-temperature state, the CPU 303 advances the processing from S32 to S34 and performs the printing scan. In the printing scan at S34, as described previously, while moving the carriage 31 in the main scanning direction, ink is ejected from the nozzle of the print head 12. After that, until printing of an image for the printing medium 11 corresponding to one page is terminated, the printing scan at S34 and the conveyance operation at S35 are repeated (S38).

At this time, the CPU 303 determines whether or not the status of the motors (the conveyance motor 23 and the feed motor 45) is the raised-temperature state (S36) before the conveyance operation of the printing medium 11 (S35). In a case where the status of the motors is the raised-temperature state, the CPU 303 waits until a predetermined cooling time elapses in order to cancel the raised-temperature state, that is, to bring the motors into the normal-temperature state (S35). After the completion of the printing operation for the printing medium 11 corresponding to one page, the printing medium 11 is discharged (S38, S39). In a case where the status of the conveyance motor 23 or the feed motor 45 is the raised-temperature state, it is possible to cancel the raised-temperature state and bring about the normal-temperature state by performing waiting processing (S33, S37) to suspend the drive of the motor and wait until a predetermined cooling time elapses.

There may be a case where the determination at S27 in FIG. 6 is not performed in order to keep throughput. Specifically, a configuration may be accepted in which in the raised-temperature detection processing of the feed motor 45, even in a case where the managed elapsed time of the time management counter for the feed motor 45 is less than a predetermined time, the CPU 303 does not advance the processing to S27 and skips S27 and terminates the detection processing. That is, as the control aspect by the CPU 303, as described previously, it is possible to include the control aspect including S27 in FIG. 6 and the control aspect in which S27 is skipped, and to select those control aspects by taking into consideration throughput and the like of the printing apparatus.

### Second Embodiment

As described previously, the maintenance mechanism 32 (see FIG. 1) of the printing apparatus 100 is provided with a wiper (not shown schematically) for wiping off foreign matter, such as ink, attached to the nozzle surface of the print head 12 at the time of the non-printing operation. This wiper is driven by the feed motor 45. As described previously, the feed motor 45 is also the drive source of the pickup roller 42 and the third conveyance roller 43, and the pickup roller 42 and the third conveyance roller 43 are configured not to drive while the wiper is driving. That is, the drive period of the wiper and the drive period of the pickup roller 42 and the third conveyance roller 43 are in an exclusive relationship. The maintenance of the print head 12 (head maintenance) such as this is performed in a state where the printing medium 11 does not exist in the conveyance path of the printing medium 11 so that the printing medium 11 on the platen 10 is not affected by ink scattering and the like by the wiper.

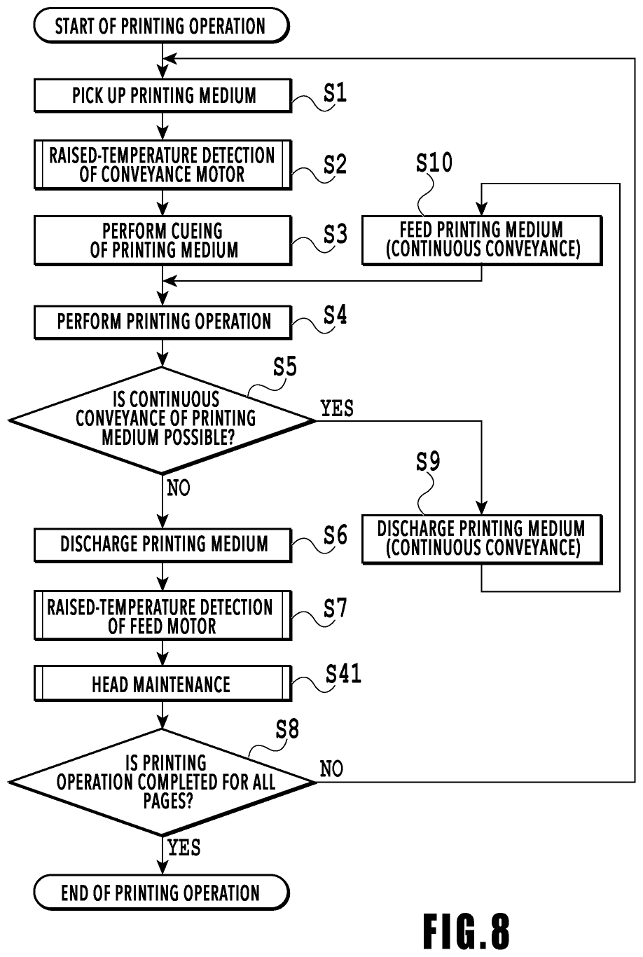

FIG. 8 is a flowchart for explaining the printing operation of the printing apparatus 100 in the present embodiment and symbol “S” in explanation of each piece of processing means a step. S1 to S10 in FIG. 8 are the same as S1 to S10 in FIG. 5 in the embodiment described previously. In the present embodiment, after the raised-temperature detection (S7) of the feed motor 45, the head maintenance to wipe off foreign matter, such as ink, attached to the nozzle surface of the print head 12 by using the wiper of the maintenance mechanism 32 is performed (S41). Further, in the present embodiment, in a case where the head maintenance (S41) is necessary at the time of determination of whether or not the continuous conveyance of the printing medium 11 is possible (S5), it is determined that the continuous conveyance is not possible and the CPU 303 advances the processing to the next discharge processing (S6). That is, at S5, in a case where the raised-temperature detection (S7) of the conveyance motor 23 (S2) or the raised-temperature detection of the feed motor 45 is necessary, or in a case where the head maintenance (S41) is necessary, it is determined that the continuous conveyance is not possible.

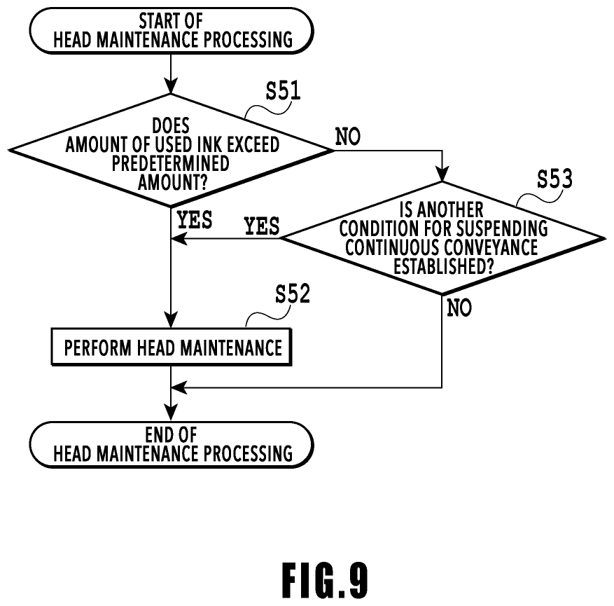

FIG. 9 is a flowchart for explaining the processing of the head maintenance (S41) in FIG. 8 and symbol “S” in explanation of each piece of processing means a step.

First, the CPU 303 determines whether or not the amount of ink used during the printing operation has exceeded a predetermined amount (S51). In a case where the amount of ink used during the printing operation has exceeded the predetermined amount, the CPU 303 determines that the head maintenance is necessary and performs the head maintenance (S52). Specifically, the CPU 303 moves the carriage 31 to the position of the wiper of the maintenance mechanism 32 and after connecting the feed motor 45 and the wiper by a power transmission mechanism, not shown schematically, the CPU 303 moves the wiper and wipes off foreign matter, such as ink, attached to the nozzle surface of the print head 12 (wiping). On the other hand, in a case where the determination at S51 indicates that the amount of ink used during the printing operation has not exceeded a predetermined amount, the CPU 303 determines whether or not another condition for suspending the continuous conveyance is established other than the head maintenance (S53). In a case where another condition is established, the head maintenance (S52) is performed even though the head maintenance is not necessary. In a case where the head maintenance is not necessary and another condition for suspending the continuous conveyance is not established, the CPU 303 determines that the continuous conveyance is possible and terminates the processing in FIG. 9 without performing the head maintenance. It is possible to make use of the determination results of whether or not the amount of ink used during the printing operation has exceeded the predetermined amount as a determination condition of whether or not the continuous conveyance of the printing medium 11 is possible at S5 in FIG. 8. Specifically, in a case where the amount of ink used during the printing operation has exceeded the predetermined amount, it is necessary to perform the head maintenance, and therefore, at S5 in FIG. 8, the CPU 303 determines that the continuous conveyance of the printing medium 11 is not possible.

Further, in the present embodiment, it is possible to perform the raised-temperature detection processing of the motor, similar to that in FIG. 6 described previously. In this case, it may also be possible to add the condition of whether or not to perform the head maintenance as the determination-target condition at S27 in FIG. 6, that is, as another condition for suspending the continuous conveyance. More specifically, in a case where the head maintenance is performed, the continuous conveyance is not possible, and therefore, even though the managed elapsed time of the time management counter is not longer than or equal to the predetermined time, the raised-temperature detection of the motor is performed (S22).

Further, in the present embodiment, even though the head maintenance is not necessary, the head maintenance (S53, S52 in FIG. 9) is performed. However, in a case where the head maintenance is performed frequently, there is a possibility of a reduction in productivity in the printing apparatus and an increase in the amount of consumed ink accompanying the head maintenance. In the case such as this, at S53 in FIG. 9, it may also be possible to lay down a condition that the CPU 303 does not advance the processing to S52 immediately in a case where a condition that suspends the continuous conveyance is established by a factor other than the head maintenance.

In the present embodiment, as in the embodiment described previously, it is possible to increase productivity in the printing apparatus by reducing the frequency of suspensions of the continuous conveyance of the printing medium 11 at S5 in FIG. 8 by the processing at S53 in FIG. 9.

### Other Embodiments

The plurality of pieces of processing performed at the time of suspension of the conveyance of the printing medium in the above-described embodiments is not limited to the processing relating to the printer unit including the print head and the conveyance mechanism of the printing medium, and any processing may be accepted as long as it is performed in the printing apparatus and the number of pieces of processing is also not limited. What is required is that it is possible to, in a case where one of those pieces of processing is performed, perform at least another piece of processing.

As another embodiment, it is possible to apply the present invention to a printing apparatus of various methods, such as an electrophotographic printing apparatus, other than the ink jet printing apparatus. Further, the feed mechanism of a printing medium is not limited to the cassette system and for example, the feed mechanism may be the feed system in which a printing medium is inserted from the rear of the apparatus and a manual feed system.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-144922 filed Aug. 1, 2018, which is hereby incorporated by reference wherein in its entirety.

What is claimed is:

1. A printing apparatus comprising:
a first drive motor that drives a feed roller feeding a printing medium;
a second drive motor that drives a conveyance roller conveying the printing medium fed by the feed roller;
a printing unit configured to print an image on the printing medium conveyed by the conveyance roller;
a conveyance unit configured to control drive of the first drive motor and the second drive motor and perform continuous conveyance that conveys a preceding printing medium and a following printing medium continuously;
a raised-temperature detection processing unit configured to perform raised-temperature detection processing to detect a raised-temperature state of the first drive motor and the second drive motor based on a predetermined condition; and
a control unit configured to perform, in a case where one drive motor of the first drive motor and the second drive motor does not satisfy the predetermined condition and the other drive motor satisfies the predetermined condition, control so as to perform, after suspending the continuous conveyance, the raised-temperature detection processing of the one drive motor that does not satisfy the predetermined condition.

2. The printing apparatus according to claim 1, wherein
the raised-temperature detection processing unit performs the raised-temperature detection processing on the predetermined condition that elapsed time from the previous raised-temperature detection processing exceeds a threshold value.

3. The printing apparatus according to claim 1, wherein
the conveyance unit stops the continuous conveyance in a case where at least one drive motor of the first drive motor and the second drive motor satisfies the predetermined condition for performing the raised-temperature detection processing.

4. The printing apparatus according to claim 1, wherein
the first drive motor is PWM-controlled,
the second drive motor is PWM-controlled, and
the raised-temperature detection processing includes processing to drive the first drive motor and detect temperature of the first drive motor based on a pulse width of a drive pulse of the first drive motor and processing to drive the second drive motor and detect temperature of the second drive motor based on a pulse width of a drive pulse of the second drive motor.

5. The printing apparatus according to claim 4, wherein
the raised-temperature detection processing includes processing to cool the first drive motor in a case where temperature of the first drive motor exceeds a predetermined first temperature and processing to cool the second drive motor in a case where temperature of the second drive motor exceeds a predetermined second temperature.

6. The printing apparatus according to claim 5, wherein
the processing to cool the first drive motor is processing to stop the first drive motor for a predetermined first time and
the processing to cool the second drive motor is processing to stop the second drive motor for a predetermined second time.

7. The printing apparatus according to claim 1, wherein
the printing unit includes a print head capable of ejecting ink and a recovery mechanism that performs recovery processing for keeping an ink ejection state of the print head favorable and
the control unit causes the recovery mechanism to perform, after suspending the continuous conveyance, the recovery processing in a case where the one drive motor does not satisfy the predetermined condition and the other drive motor satisfies the predetermined condition.

8. The printing apparatus according to claim 7, wherein
the recovery processing includes wiping processing to wipe an ejection port surface on which an ejection port for ejecting ink is formed.

9. The printing apparatus according to claim 1, wherein
the control unit resumes conveyance of the printing medium by the conveyance unit after termination of execution of the raised-temperature detection processing.

10. The printing apparatus according to claim 1, wherein
the conveyance unit conveys a plurality of the printing media continuously in such a manner that the preceding printing medium and a part of the following printing medium overlap.

11. A control method of a printing apparatus that prints an image on a printing medium to be conveyed, the control method comprising:
a continuous conveyance step of continuously conveying a preceding printing medium and a following printing medium by controlling drive of a first drive motor that drives a feed roller feeding the printing medium and a second drive motor that drives a conveyance roller conveying the printing medium fed by the feed roller;
a raised-temperature detection step of performing raised-temperature detection processing to detect a raised-temperature state of the first drive motor and the second drive motor based on a predetermined condition; and
a control step of causing, in a case where one drive motor of the first drive motor and the second drive motor does not satisfy the predetermined condition and the other drive motor satisfies the predetermined condition, the raised-temperature detection processing of the one drive motor that does not satisfy the predetermined condition to be performed after suspending the continuous conveyance.

12. A non-transitory computer readable storage medium storing a program for causing a computer to perform a control method of a printing apparatus that prints an image on a printing medium to be conveyed, the control method comprising:
a continuous conveyance step of continuously conveying a preceding printing medium and a subsequent printing medium by controlling drive of a first drive motor that drives a feed roller feeding the printing medium and a second drive motor that drives a conveyance roller conveying the printing medium fed by the feed roller;
a raised-temperature detection step of performing raised-temperature detection processing to detect a raised-temperature state of the first drive motor and the second drive motor based on a predetermined condition; and
a control step of causing, in a case where one drive motor of the first drive motor and the second drive motor does not satisfy the predetermined condition and the other drive motor satisfies the predetermined condition, the raised-temperature detection processing of the one drive motor that does not satisfy the predetermined condition to be performed after suspending the continuous conveyance.
